(19) United States
(12) Patent Application Publication
(10) Pub. No.: US 2003/0154585 A1
(43) Pub. Date: Aug. 21, 2003

(54) Mechanical cone scarfing deburrer to remove oxygen cutting burrs and cutting beads after thermo-chemical cross-cutting or slitting steel workpieces such as slabs, blooms and billets

(76) Inventor: Horst Karl Lotz, Hauterive NE (CH)

Correspondence Address: Brij K. Agarwal, 44th Floor, 600 Grant Street, Pittsburgh, PA, 15219, US

(21) Appl. No.: 10/271,127

(22) Filed: Oct. 15, 2002

(30) Foreign Application Priority Data
Feb. 16, 2002 (EP) 02003618.2

(51) Int. Cl. B23P 23/04

(52) U.S. Cl. 29/33 A

(57) ABSTRACT

Owing to the application of a cone stub with scarfing knives on a drive that is positioned at an angle and the resilient adjustability of the cone stub, a safe and economical deburring process using only marginal space is possible.

### BACKGROUND OF THE INVENTION

1. Field of the Invention

The present invention relates generally to deburring equipment.

2. Description of the Related Art

With the worldwide increase in the number of continuous steel casting plants, the increasing application of oxygen cutting procedures to subdivide or slit and to improve existing plants mechanical deburring or debeading procedures have been gaining importance. Such procedures are the removal of oxygen cutting burrs from the bottom faces or the removal of oxygen cutting beads usually from the top faces of slabs, blooms and billets respectively, if possible immediately after the cross-cutting or slitting procedure. A great number of deburrers exist by now, but the costs, the deburring rates, the maintenance efforts, favourable places of installation (within the production process) and, above all, injury potentials and high noise levels still leave much to be desired.

The following deburring principles with the appertaining main components and the shortcomings and disadvantages meanwhile being complained about are valid for all known designs of deburrers, all of which have been in operation successfully.

Deburring principles:

The workpieces are positioned in a stationary manner with the front or the rear cutting burr above the deburrer and are deburred when the roller table, the driving pulley or the shifting equipment are moved.

The workpieces are positioned in a stationary manner with the front or the rear cutting burr above the deburrer and are deburred when the deburrer is shifted or when its drum is rotated against the fixed workpiece.

The workpieces are moved on a roller table at operating or conveying speed, the front and the rear oxygen cutting burr are removed from the workpiece when the deburrer passes and is afterwards shifted in opposite direction.

The workpieces are moved on a roller table at operating or conveying speed, the front and the rear oxygen cutting burr are knocked off of the workpiece when one of the deburrer rotors passes and is afterwards rotated in opposite direction.

For that purpose, the upright or shifting deburrers of the first three systems are equipped with straight, horizontal shear bars or with square or round shear blocks that are arranged next to each other and that can perhaps be lifted and lowered elastically.

The deburrers of the second system are equipped along their circumferences with round, if necessary spring borne shear blocks. The heavy drum is hydraulically pushed against the workpiece and is then rotated with an enormous expenditure of force (the burrs are broken). As with tough steel qualities the burrs are only partially turned off or folded up, there are not only high costs but also low deburring rates and big positioning efforts.

The deburrers of the fourth system are equipped with small hinged hammers along their circumference and over the entire length of the rotor. These hammers are lifted up by the centrifugal force when the rotor turns at high speed, thus removing the oxygen cutting burr passing above by knocking it into many little pieces. The high speed required also produces great centrifugal forces entailing the danger of residual burr being hurled round making expensive protection equipment necessary. The expenditures for maintenance and spare parts are very extensive, and the deburring rates also leave much to be desired.

A so far successful, but from the above-mentioned systems differing design is a deburring machine that travels longitudinally to the oxygen cutting burr at rate of advance. This machine presses a plate-type shearing tool on a lever from below against the bottom face of the workpiece and shears or knocks off the cutting burr while this lever oscillates to and fro. This design, which is mostly applied to deburr resting workpieces, results in a limited production due to the limited size of the shearing tool and is applicable only under certain restricting circumstances, such as an enormous amount of time, extensive space requirements and especially high costs of installation.

Today's most successful deburrers are described in short in the following:

A stationary or movable deburrer with a piston body out of which compressed air driven pistons that are positioned next to each other and that hold shear caps as tools, push upwards and press against the bottom face of the workpieces and shear or force off the cutting oxygen burr—depending on the material composition and the temperature—when the deburrer or the workpiece are shifted. The main disadvantage of this deburrer is its restricted or awkward and involved application on permanently moving workpieces, its many moving parts and the at times marginal deburring rate (below 99%), i.e., after the deburring process there are still remains of cutting oxygen burrs on the workpiece, or the burrs are merely folded up. Also, small pieces of the cutting oxygen burrs can jam between neighboring pistons and shear caps thus reducing the efficiency of the deburrer, which decreases the deburring rate as well. Accessibility, safety, availability and a marginal noise level during operation are the advantages of this deburrer.

A tiltable deburrer with a continuous and straight shear bar in the front and at the back is the simplest and most economical design of a deburrer. Although one shear bar is well pressed underneath the bottom face of the workpiece each time the deburrer is tilted, the bad deburring rates in case of an inclined, convex or concave bottom face and the unavoidable travel to and fro are the unforgivably great disadvantages of this type of deburrer despite the deburring forces being kept at a minimum owing to an inclined, evenly and increasingly gripping shear bar thus keeping the noise level during operation very low.

The so far most favourable deburrer for a timewise independent, fast deburring process of workpieces that pass non-stop, with the least space requirement in the roller table, e.g. behind a continuous steel casting installation inside a roller table gap, is without a doubt the rotary deburrer with the fast turning rotor that is equipped with hammers. The expenditure of force and the installation costs are of course rather high, but an inclined position of the workpiece, convex and concave bottom faces and different travel rates are—if within limits—no problem for this type of deburrer as long as the however small tolerance distance to the bottom face is observed.

Other problems, though, stand out:

As the oxygen cutting burr is often and unevenly broken off with great force and very quickly because of the numerous little hammers, a lot of noise is produced. There is relatively much wear and hammers are often destroyed. Just as often or even more often, parts of burrs are only folded up and are thus not removed. The maintenance effort is especially extensive as the small hammers are to be replaced and as it is necessary to remove and reinstall protection plates especially because these plates are to be installed thoroughly and with a lot of care to withstand the pieces of burr and hammer parts that are being hurled round. Otherwise, severe injuries and damage are the result.

Much quieter and safer is a deburrer that operates at a lower rate, for example at roller table speed. This takes a beam-shaped piston body that is positioned under the workpiece and that is equipped with compressed air operated deburrer pistons. After it is pressed against the bottom face, this piston body is moved countercurrent to the resting or only slowly moving cutting burr. The workpiece with the oxygen cutting burr can also be moved towards the stationary deburrer and that twice per workpiece, once towards each end of the workpiece and beyond. There are no metal pieces being hurled round and there is no elaborate protection equipment, but the workpiece is to be moved back and forth which is very time-consuming and requires a lot of space. This design has also the disadvantage of oxygen cutting burrs or parts of it being merely folded up.

### SUMMARY OF THE INVENTION

An aspect of the present invention is to provide a deburring apparatus for removing at least one of a burr and a bead from a workpiece, in which the general nature of the deburring apparatus can be stated as including a drive unit, a deburring head being disposed on the drive unit and being rotatable by the drive unit about an axis, at least a first knife mounted on the hub, and at least a portion of the at least first knife being substantially spiral-shaped.

An aspect of the present invention is to provide a deburring apparatus for removing at least one of a burr and a bead from a workpiece, in which the general nature of the deburring apparatus can be stated as including a drive unit including a biasing system, a deburring head disposed on the drive unit and being rotatably driveable by the drive unit about an axis, at least a portion of the deburring head being generally conic, at least a first knife, the least a first knife being fixedly mounted on the hub, and the deburring head being translatable along the axis and being biased toward the workpiece by the biasing system.

### BRIEF DESCRIPTION OF THE DRAWINGS

A further understanding of the invention can be gained from the following Description of the Preferred Embodiments when read in conjunction with the accompanying drawings in which:

FIG. 1 is a front elevational view, partially cut away, of a first embodiment of the present invention mounted on a foundation and engaging a deburring surface of a workpiece;

FIG. 2 is a perspective view of a portion of the first embodiment;

FIG. 3 is a front elevational view, partially cut away, of a second embodiment of the present invention mounted on a foundation and engaging a deburring surface of a workpiece; and

FIG. 4 is a perspective view of a portion of the second embodiment.

Similar numbers refer to similar parts throughout the specification.

### DESCRIPTION OF THE PREFERRED EMBODIMENTS

As will be set forth in greater detail below, an aspect of the present invention is to provide a mechanical cone scarfing deburrer to remove oxygen cutting burrs and cutting beads after thermo-chemical cross-cutting or slitting of steel workpieces such as slabs, blooms and billets in hot and cold condition either stationary or moving on a roller table. The deburrer includes a cone stub drum that may include cone stub segments. The deburrer is oriented at an angle of 45° to 75° with respect to a surface line of the workpiece, and may include a portion that is substantially level or parallel with the respective surface line of the workpiece and may be positioned horizontally under the slit or cross-cut workpiece.

The deburrer may also include on the surfaces one or more scarfing knives arranged spirally at an angle of 0° to 45° to the cone centre axis. A hub of the cone stub and of any segment spokes is movable on a shaft (this shaft correspondingly being arranged at an angle of 45° to 75° to the horizontal,) and may be movable in a spring type manner by means of compressed air, hydraulics or a coil spring. This shaft, resistant to bending, may be designed as a spline shaft stub that may be held in a pair of bearings for slitting and cross-cutting forces inside a deburrer housing and that may be motor-driven or turned by a hydraulic drive.

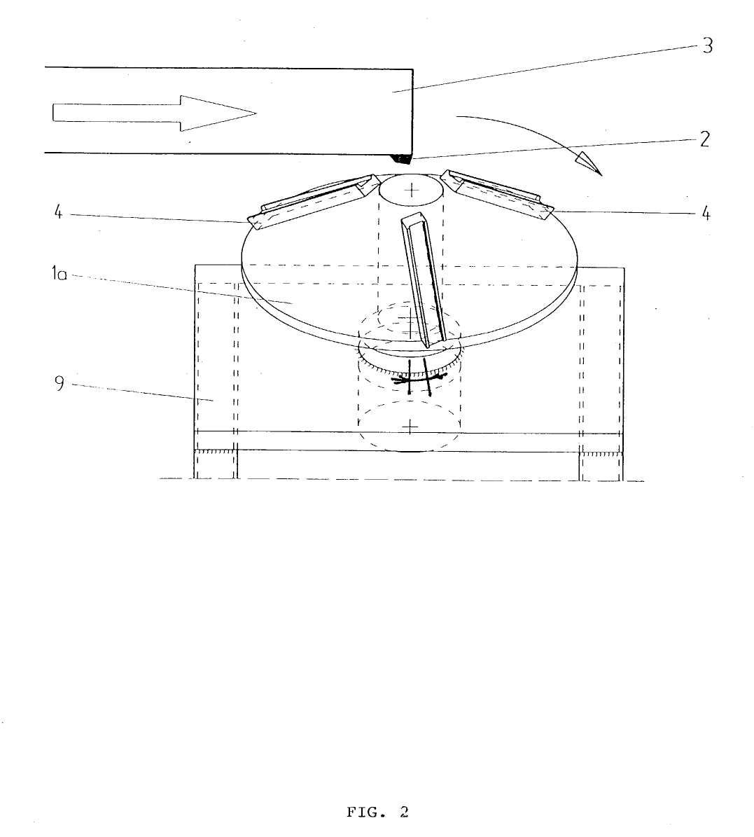

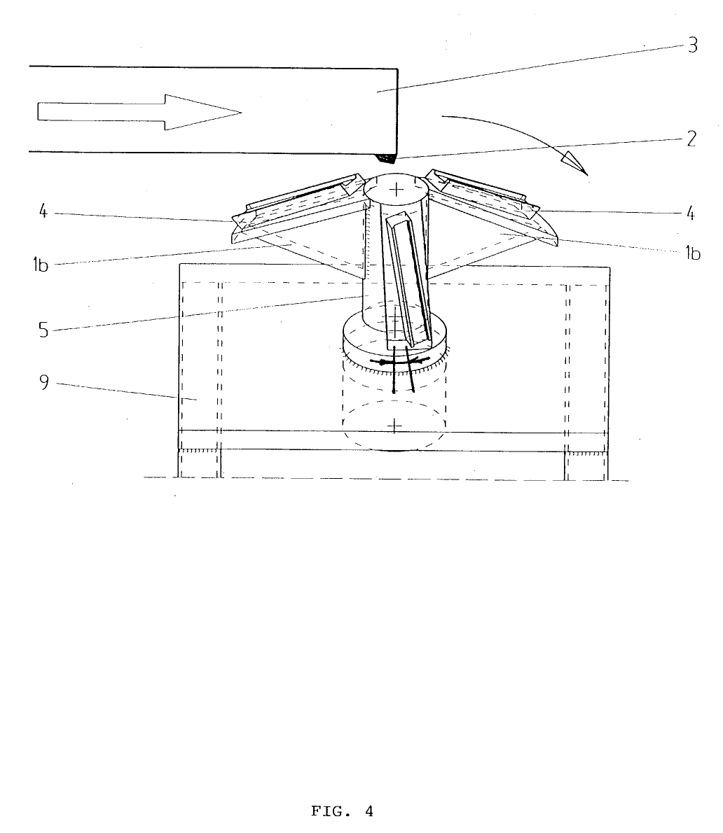

The size, quantity and arrangement of the spiral scarfing knives on the surface shell of the cone stub or of its corresponding segment spokes may be chosen such that the workpiece, while it is passing through, does not touch the surface of the cone stub shell or the scarfing knives in a position—the centre of a region between the scarfing knives under the bottom face of the workpiece (FIGS. 2 and 4)—even when the surface slightly lowers.

The height of the hub of the cone stub may be adjustable by means of a coil spring, compressed air, hydraulics or a mechanically adjustable support. If compressed air is applied the adjustment is to be carried out using an upper and a lower stop.

For longitudinal deburring, the shell upper line of the cone stub, which is equipped with scarfing knives, is parallel or almost parallel or positioned at a small angle with respect to the oxygen cutting burr, whereby this line may be pointing slightly at an angle extending underneath the workpiece. Thus contact is made under the workpiece and not on one of the front faces. The deburrer accordingly may be positioned on the tilted axle in a manner enabling it to tilt upwards at the start of the deburring process.

The deburrer housing, which holds the drive, the pair of bearings, the shaft and the deburrer cone with hub and scarfing knives, may be equipped with a simple substructure housing that is firmly anchored in a foundation. Owing to this substructure housing and by means of adjusting bolts, the position of the housing may be adjusted regarding its height and in longitudinal and crosswise direction. An axle with bearings and a spring borne element are arranged between the substructure housing and the deburrer housing so that the cone scarfing deburrer can adapt to the bottom face of the workpiece even in case of twisted cross cuts within the deburring area.

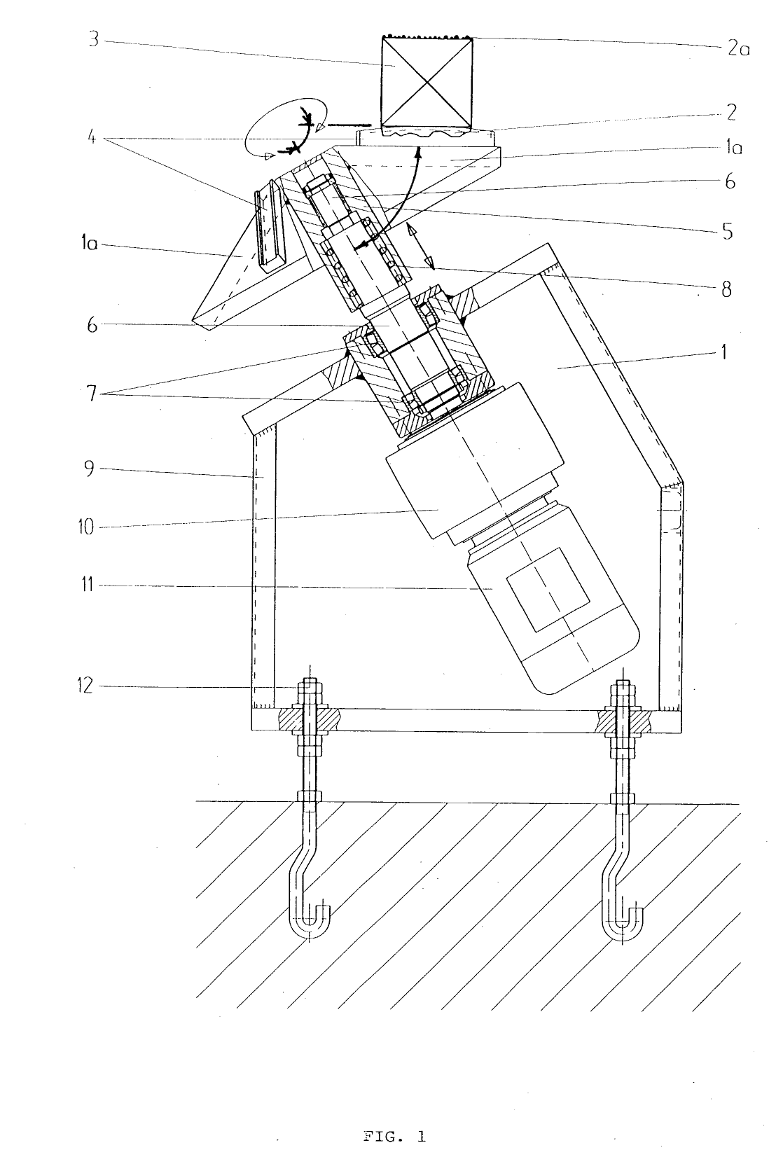

The design of a cone scarfing deburrer (1) as depicted in FIGS. 1 and 2, described in the following and claimed as novelty worthy of protection, is basically characterized by a design and an operation that correspond to that of a scarfing deburrer or a scarfing deburring process respectively. That means that an oxygen cutting burr (2) or cutting bead (2a) is removed from a workpiece (3) with an—over the entire width of the workpiece—even, steady, rather slow movement of about 3 m/min. to about 150 m/min. above the speed of the burr during workpiece conveyance. The shearing tool used is intended to be as long as a burr; it is a continuous blade, the so-called scarfing knife (4), although may consist of 20 mm to 100 mm long pieces.

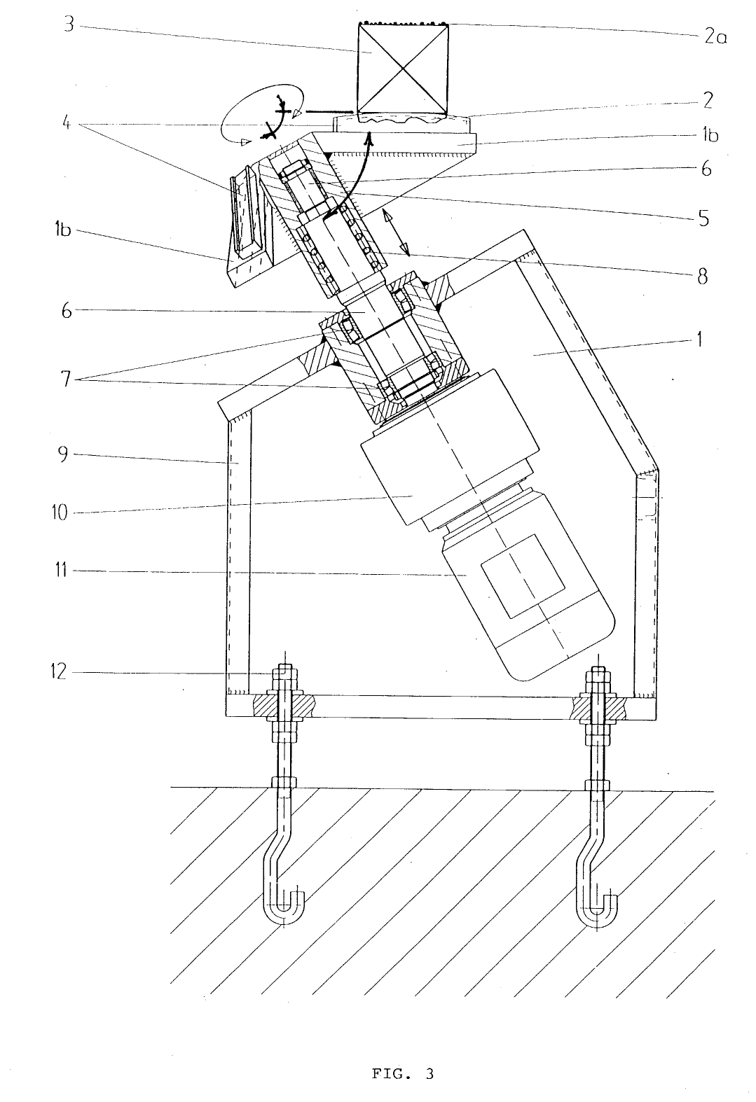

This scarfing knife (4) presses along the workpiece against the oxygen cutting burr (2) while the knife (4) is positioned therebelow 5° to 30° to the oxygen cutting burr (2) and thus therebelow 85° to 60° to the direction of advance of the scarfing knife (4). The scarfing knife (4)—with a cutting angle=working angle of 45° to 90° between the bottom face of the workpiece (3) and the scarfing knife (4)—is designed as a scarfing knife spiral (4) or as multiple scarfing knife spirals (4) with a spiral distance appropriate to grip the burrs. That means that the scarfing knife is a longitudinal spiral with a large diameter and a large inclination on the shell of one cone-shaped deburrer roll (1a) or on its corresponding deburrer cone spokes (1b) as depicted in FIG. 3.

For that reason per rotation only one point of the scarfing knife (4) gets in contact with the workpiece (3) and the oxygen cutting burr (2) in direction of advance and also upwards, the latter being carried out by an elastic, cushioned push-up of the hub (5). The cone scarfing deburrer (1) suggested for that purpose may include the following components with the appertaining functions: The cone stub (1a) or the cone spokes (1b) hold a scarfing knife spiral (4) to remove oxygen cutting burrs (2) or oxygen cutting beads (2a) from the workpiece (3). This scarfing knife spiral (4) may consist of several 20 mm to 100 mm long scarfing knife parts (4) that are bent and twisted to suit the spiral design and is installed with its hub (5) on a shaft (6)—perhaps a spline shaft (6)—in a movable manner.

The shaft (5) is held in a stable pair of bearings (7) to absorb great longitudinal and shearing forces. A compression spring (8) is positioned between the hub (5) and the spline shaft (6), in order to press the scarfing knives (4) against the bottom face of the workpiece on the one hand and to yield when the height of the workpiece (3) is changed on the other hand. Instead of applying a compression spring (8), the hub (5) can be used here too as a cylinder and the shaft (6) as a stationary piston for resilience with compressed air, even for lifting and lowering the cone stub (1a). An advantage of the cone scarfing deburrer (1) is that the shaft (6) is used for the rotary deburring energy as well as for enabling a press-and-shift movement in height.

This also enables a slight extraction upwards and at an angle for replacement and repair purposes. The pair of bearings (7) is positioned inside a frame (9) or housing in which the gear (10) and the motor (11) can be found as well. This frame (9) is fixed to a foundation plate or in the foundation by means of adjusting bolts (12) and nuts and can thus be adjusted in height, laterally, and longitudinally. The drive unit with motor (11) and gear (10) is flanged to the inside of the frame (9) and is connected with the shaft (6).

The cone scarfing deburrer (1) can also be equipped with deburrer cone spokes (1b) instead of a deburrer cone stub (1a). In this case, the conical shell (1a), i.e. the cone roll, is replaced by one, two, three or more cone spokes (1b) for manufacturing reasons. These are wide enough to hold the scarfing knife spirals (4). The spokes are held together at the inside by means of the hub (5).

In any of these cases, the workpiece (3) may move—while the cone scarfing deburrer (1) is in resting position—across a gap or region between the scarfing knives (4) or between the cone spokes (1b) to enable free passage of the workpiece (3) between each of the deburring sequences. For that purpose, the motor (11) is to be braked in a correspondingly accurate manner after a deburring process has been completed. For the ensuing deburring process of the workpiece—crop or end—(3) the direction of rotation of the motor (11) is to be changed accordingly.

For a longitudinal deburring process as opposed to the similar crosswise deburring process the cone scarfing deburrer (1) is to be positioned just about parallel underneath the longitudinal burr, and to remove oxygen cutting beads (2a) above the workpiece (3) on the upper workpiece edge is turned by 180°.

What is claimed is:

1. A deburring apparatus for removing at least one of a burr and a bead from a workpiece, the deburring apparatus comprising:
a drive unit;
a deburring head being disposed on the drive unit and being rotatable by the drive unit about an axis;
at least a first knife mounted on the hub; and
at least a portion of the at least first knife being substantially spiral-shaped.

2. The deburring apparatus as set forth in claim 1,
in which the axis is oriented at an angle of about 45° to 75° with respect to a deburring surface of the workpiece.

3. The deburring apparatus as set forth in claim 2, in which the deburring head includes a head surface, the at least first knife being mounted on the head surface, the head surface being oriented with respect to the axis at an angle substantially the same as the angle at which the axis is oriented with respect to the deburring surface of the workpiece.

4. The deburring apparatus as set forth in claim 2,
in which the deburring head is movable longitudinally along the axis.

5. The deburring apparatus as set forth in claim 4,
in which the drive unit includes a shaft that is rotatable about the axis, the deburring head being mounted on the shaft.

6. The deburring apparatus as set forth in claim 5,
in which the shaft is a spline shaft.

7. The deburring apparatus as set forth in claim 5,
in which the drive unit includes a biasing system, the deburring head being biased toward the workpiece by the biasing system.

8. The deburring apparatus as set forth in claim 7,
in which the biasing system includes at least one of a spring, compressed air, and hydraulics.

9. The deburring apparatus as set forth in claim 1,
in which the deburring head includes a head surface, at least a portion of the head surface being in the shape of a substantially conic segment.

10. The deburring apparatus as set forth in claim 9,
in which the at least first knife is mounted on the head surface;
a portion of the head surface that is adjacent the workpiece and on which the at least first knife is disposed including a line that is oriented at a slight nonzero angle with respect to the at least one of a burr and a bead of the workpiece.

11. The deburring apparatus as set forth in claim 1,
in which the deburring head includes at least a first spoke;
the at least first spoke including a head surface in the shape of a substantially conic segment;
the at least first knife being mounted on the at least first spoke.

12. The deburring apparatus as set forth in claim 1,
in which the deburring head includes a plurality of spokes;
each spoke including a head surface in the shape of a substantially conic segment;
the at least first knife being mounted on one of the spokes;
each of the other spokes having mounted thereon a knife similar to the at least first knife.

13. The deburring apparatus as set forth in claim 1,
in which the at least first knife is spirally oriented at a nonzero angle of at most about 45° with respect to the axis.

14. The deburring apparatus as set forth in claim 1,
in which the drive unit includes at least a first adjusting member, the adjusting member being structured to mount the deburring apparatus to a foundation and to permit adjustment of the deburring head in at least one of three mutually orthogonal directions with respect to the foundation.

15. A deburring apparatus for removing at least one of a burr and a bead from a workpiece, the deburring apparatus comprising:
a drive unit including a biasing system;
a deburring head disposed on the drive unit and being rotatably driveable by the drive unit about an axis;
at least a portion of the deburring head being generally conic;
at least a first knife;
the least a first knife being fixedly mounted on the hub; and
the deburring head being translatable along the axis and being biased toward the workpiece by the biasing system.

16. The deburring apparatus as set forth in claim 15,
in which at least a portion of the at least first knife is substantially spiral-shaped.

17. The deburring apparatus as set forth in claim 15,
in which the axis is oriented at an angle of about 45° to 75° with respect to a deburring surface of the workpiece.

18. The deburring apparatus as set forth in claim 17, in which the deburring head includes a head surface, the at least first knife being mounted on the head surface, the head surface being oriented with respect to the axis at an angle substantially the same as the angle at which the axis is oriented with respect to the deburring surface of the workpiece.

19. The deburring apparatus as set forth in claim 15,
in which the drive unit includes a shaft that is rotatable about the axis, the deburring head being mounted on the shaft.

20. The deburring apparatus as set forth in claim 19,
in which the deburring head is translatably mounted on the shaft.

21. The deburring apparatus as set forth in claim 20,
in which the shaft is a spline shaft.

22. The deburring apparatus as set forth in claim 15,
in which the biasing system includes at least one of a spring, compressed air, and hydraulics.

23. The deburring apparatus as set forth in claim 15,
in which the deburring head includes a head surface, at least a portion of the head surface being in the shape of a substantially conic segment.

24. The deburring apparatus as set forth in claim 23,
in which the at least first knife is mounted on the head surface;
a portion of the head surface that is adjacent the workpiece and on which the at least first knife is disposed including a line that is oriented at a slight nonzero angle with respect to the at least one of a burr and a bead of the workpiece.

25. The deburring apparatus as set forth in claim 15,
in which the deburring head includes at least a first spoke;
the at least first spoke including a head surface in the shape of a substantially conic segment;
the at least first knife being mounted on the at least first spoke.

26. The deburring apparatus as set forth in claim 15,
in which the deburring head includes a plurality of spokes;
each spoke including a head surface in the shape of a substantially conic segment;
the at least first knife being mounted on one of the spokes;
each of the other spokes having mounted thereon a knife similar to the at least first knife.

27. The deburring apparatus as set forth in claim 15,
in which the at least first knife is spirally oriented at a nonzero angle of at most about 45° with respect to the axis.

28. The deburring apparatus as set forth in claim 15,
in which the drive unit includes at least a first adjusting member, the adjusting member being structured to mount the deburring apparatus to a foundation and to permit adjustment of the deburring head in at least one of three mutually orthogonal directions with respect to the foundation.
